(19) United States
(12) Patent Application Publication
(10) Pub. No.: US 2013/0117592 A1
(43) Pub. Date: May 9, 2013

(54) POWER CAPPING SYSTEM

(71) Applicants: Daniel Humphrey, Houston, TX (US); David Paul Mohr, Spring, TX (US); Zachary J. Gerbozy, Spring, TX (US)

(72) Inventors: Daniel Humphrey, Houston, TX (US); David Paul Mohr, Spring, TX (US); Zachary J. Gerbozy, Spring, TX (US)

(21) Appl. No.: 13/810,357

(22) PCT Filed: Sep. 16, 2010
(86) PCT No.: PCT/US10/49138

§ 371 Date: Jan. 15, 2013

(51) Int. Cl. G06F 1/32

(52) U.S. Cl. CPC G06F 1/3296
USPC 713/320

(57) ABSTRACT

A method for power capping is disclosed. The power supplied to a load from a power supply is compared to a power capping limit 302. When the power drawn by the load exceeds the power capping limit, power to the load is supplied by both the power supply and an energy storage device 304.

### BACKGROUND

Computer systems use a significant amount of power. Reducing the amount of power used and/or using the power more efficiently helps reduce the cost of operating the computer systems. Operating the computer system more efficiently gives the user more results for a given amount of power used. Limiting the peak amount of power used by a computer system is sometimes called power capping. Power capping can reduce the cost of the power and cooling infrastructure by limiting the maximum lead that it most support.

Power capping can be done by monitoring the power draw of a computer system and reducing power consumption when necessary. When the power draw exceeds a threshold value, the amount of power used by the system is reduced until the power draw is below the threshold. Typically, one of the main consumers of power in a computer system is the processor. By reducing the clock speed of a processor, the total power used by the computer system may be reduced. In some computer systems, for example blade systems, power capping can be done at a system level a rack level, a blade level, or at the individual processor level.

The process of monitoring the power draw of the system and reducing the load generated by the compute in response to power draws that exceed the power capping threshold takes time. Responding more quickly to spikes or peaks in power usage by the computer system may allow a computer system to operate at a lower cost.

### BRIEF DESCRIPTION OF THE DRAWINGS

FIG. 1 is a diagram of a computer system 100 in an example embodiment of the invention.

FIG. 2 is a block diagram of power system 122 in an example embodiment of the invention.

FIG. 3 is a flow chart for managing power in an example embodiment of the invention.

### DETAILED DESCRIPTION

FIGS. 1-3 and the following description depict specific examples to teach those skilled in the art how to make and use the best mode of the invention. For the purpose of teaching inventive principles, some conventional aspects safe been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a diagram of a computer system 100 in an example embodiment of the invention. Computer system 100 comprises rack 102, processor blades 104, controller 110, bus 116, I/O board 120, auxiliary blades 118, and power system 122. Processor blades 104, controller 110, I/O board 120, and auxiliary blades 118 are mounted inside rack 102 and couple to has 116. Bus 116 may be any type of communications bus or fabric, for example a PCIe bus. Processor blades 104 may comprise one or more processors 106 and memory 108. Processors 106 are capable of operating at multiple power levels. Auxiliary blades 118 may comprise memory blades, storage blades, additional I/O blades or the like. Controller 110 may comprise one or more processor 112 and memory 114. In one example embodiment of the invention, power system 122 may be mounted inside rack 102 and coupled to bus 116. In other example embodiments of the invention, power system 122 may be external to rack 102.

In operation, controller 110 may be running code that monitors the operation of computer system 100. In one example embodiment of the invention, controller 110 will be running a power capping module. Power capping module will communicate with power system 122 to monitor and control the power draw of computer system 100.

Power system 122 may comprise one or more power supplies and one or more power controllers. Power system may also comprise an energy storage device. Energy storage device can be any type of device that can store electrical energy, for example a battery, a super capacitor, or the like. Power system is coupled to the different components of computer system 106 with a power bus (not shown for clarity) that provides power from the power system to the other components.

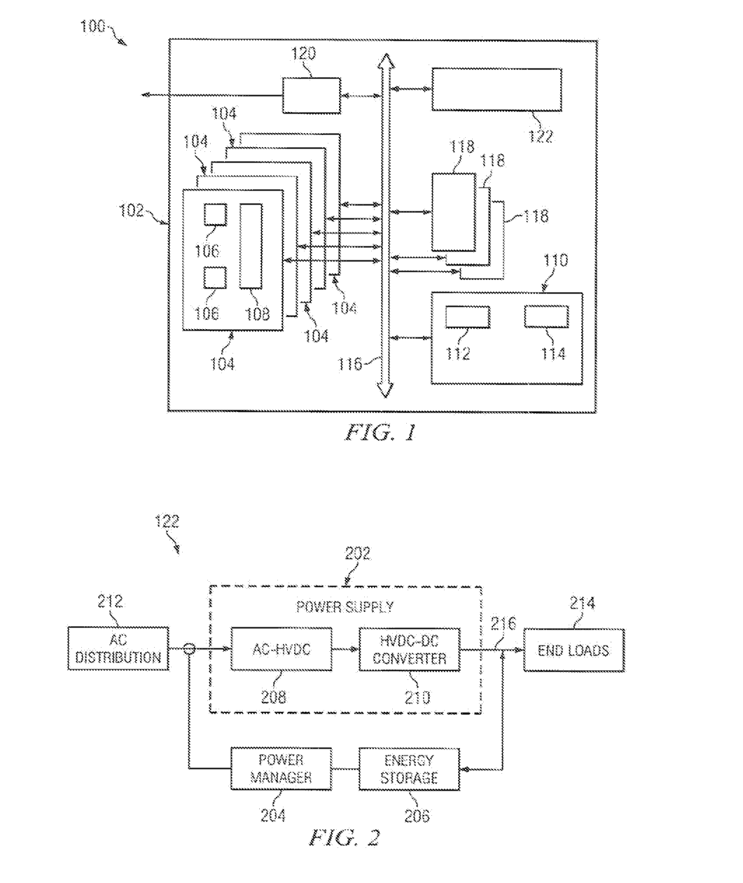

FIG. 2 is a block diagram of power system 122 in an example embodiment of the invention. Power system 122 comprises power supply 202 and energy storage device 206. Power supply 202 may comprise alternating current (AC) to high voltage direct current (HVDC) converter 208 and HVDC to DC converter 210. AC to HVDC converter 208 is coupled to an AC distribution system 212. AC to HVDC converter 208 converts this AC power from the AC distribution system 212 into high voltage DC power. AC to HVDC converter 208 is coupled to HVDC to DC converter 210. AC to HVDC converter 208 supplies high voltage DC power to HVDC to DC converter 210. HVDC to DC converter 210 is coupled to the end loads 214 of computer system 100 through a power distribution bus 216. HVDC to DC converter 210 converts the high voltage DC power into DC power at the voltages needed by the different end loads of computer system 100. End loads of computer system are for example rack 102, processor blades 104, controller 110, I/O board 120, auxiliary blades 118 and the like. Energy storage device 206 is also coupled to the power distribution has 216.

Power manager 204 monitors the total power draw of computer system 100, the power drew against the AC power distribution system, the power draw against the energy storage device, and the amount of energy currently stored in the energy storage device. In one example embodiment of the invention, power manager 204 may be located in power system 122. In another example embodiment of the system, power manager may be code running on controller 110 as part of the power capping module. The functions of power manager may also be distributed between controller 110 and power system 122. When power manager 204 determines that the power drawn from the AC distribution system has exceeded a threshold value (also called the power capping limit), power manager will enable energy storage device 206 to supply power to end loads 214. In addition, power manager may reduce the power draw of the end loads 214. By supplying power to end loads 214 from energy storage device 206, the power drawn from the AC distribution system 212 can be quickly lowered back below the threshold value. When the power draw of the system falls below the threshold value, the power manager removes energy storage device 206 as a source of power to end loads 214 and energy storage device 206 may begin to recharge.

In one example embodiment of the invention, power manager reduces the power draw of the system by reducing the clock frequency for one or more processors in the computer system. Reducing the clock frequency of a processor may also be known as throttling the processor. Other power reduction methods may also be used, for example powering down disk drives, slowing memory access, powering down auxiliary blades 118, or the like.

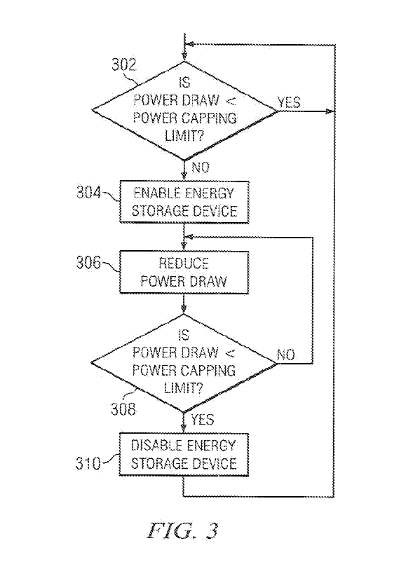

FIG. 3 is a flow chart for managing power in an example embodiment of the invention. At step 302 the power draw against the AC distribution system is compared to the power capping limit. When the power draw against the AC distribution system is less than the power capping limit, flow loops back to step 302. When the power draw against the AC distribution system, is greater than the power capping limit, flow proceeds to step 304. At step 304 the energy storage device is enabled to bring the draw against the AC distribution system back below the power capping limit. The power draw against the AC distribution system is reduced to below the power capping limit by providing power to the computer system from the energy storage device. Flow then continues at step 306 where the power draw of the computer system is reduced. At step 308 the power draw against the AC distribution system is compared to the power capping limit. When the power draw against the AC distribution system is above the power capping limit, flow returns to step 306 where the power draw of the computer system is reduced. When the power draw against the AC distribution systems is below the power capping limit, flow continues to step 310 where the energy storage device is disabled and may begin to recharge.

In one example embodiment of the invention, power capping module may monitor the power draw of the computer system at the rack, the blade and/or the processor level, in other embodiments of the invention, power capping module may monitor the power draw of the computer system only at the rack or blade level. Power capping module may monitor the power draw of computer system on a periodic bases or may monitor the power draw of the system using an event driven system. When power capping module monitors the power periodically, power capping module may poll power system 122 at a timed interval to retrieve the power draw information. When power capping module monitors the power using an event driven method, a hardware interrupt may trigger when the power draw of the system, or of a component, exceeds a threshold amount.

In another example embodiment of the invention, power manager may not lower the power draw of computer system. The power draw of the computer system may have a short peak demand that causes the power draw against the AC distribution system to exceed the power capping limit for only a short time period. When the power draw against the AC distribution system is above the power capping limit, power manager will enable the energy storage device to reduce the load against the AC distribution system. Power manager will monitor the total power draw of the computer system to determine if the power drawn by the computer system needs to be reduced. Power manager may lower the power demand of the computer system when one or more of the following occur: the power draw or load against the energy storage device is above a threshold; the total energy drawn from the energy storage device exceeds a threshold amount, for example 50% of the storage capacity; the power draw of the computer system exceeds a threshold; the energy remaining in the energy storage device falls below a threshold; or the like. When the power drawn by the computer system falls back below the power capping limit, the energy storage device will be disabled and may begin to recharge.

In one example embodiment of the invention, energy storage device may be part of power system 122. In another example embodiment of the invention, an energy storage device contained in an un-interruptible power supply may be used as the energy storage device.

In one example embodiment of the invention, the power manager may setup the energy storage device to automatically react and begin to supply power without the power manager's intervention. For example, the output of a power supply may droop from 12.3V to 12.0V as the load increases linearly from 0% to 100%. When the power manager determines that the power capping limit is at 70% of the output of the power supply, the power manager can adjust the output voltage set point to 12.09V, so that the energy storage device will start supplying power (without power manager intervention) when the load exceeds 70% of the power supply output 12.0V is 70% of the voltage droop in the power supply (12.09V=12.3−(12.3V−12.0V)*7). The power manager can limit the output of the power supply by adjusting the voltage set point to any value needed. The power manager can monitor the energy storage device or the load to determine when the energy storage device is supplying power to the load, and then react accordingly.

This invention is not limited to capping power from an AC distribution system. In some embodiments of the invention, the power draw against other parts of the power system may be capped using an energy storage device. For example a power draw against a DC power supply may be capped at a threshold value by supplementing the energy supplied by the DC power supply using an energy storage device.

1. A method for power capping, comprising:
supplying power to a load from a power source;
when the amount of power supplied is below a power capping limit then:
supplying power to the load using only the power source;
when the amount of power supplied is not below the power capping limit then:
(a) supplying power to the load from both an energy storage device and the power source;
(b) reducing the power drawn by the load.

2. The method of claim 1, further comprising:
reducing the power drawn by the load only when at least one of the following occur;
the power draw from the energy storage device is above a first power draw threshold amount;
the total energy drawn from the energy storage device exceeds an energy threshold amount;
the power draw of the load exceeds a second power draw threshold;
the energy remaining in the energy storage device falls below a energy level threshold.

3. The method of claim 1, further comprising:
when the amount of power being supplied to the load is below the power capping limit then supplying power to the load from only the power source.
when the amount of power being supplied to the load is above the power capping limit then repeat steps (a) and (b).

4. The method of claim 1, wherein the energy storage device automatically starts supplying power to the load, without the intervention of a power manager, when the power supplied is not below the power capping limit.

5. The method of claim 1, further comprising:
when the amount of power being supplied to the load is below the power capping limit then charging the energy storage device.

6. The method of claim 1, wherein the load is comprised of at least one of the following devices: a computer system 100, a rack 102, a processor blade 104, a controller 110, a bus 116, an I/O board 120, and an auxiliary blade 118.

7. The method of claim 5, wherein the power drawn by the load is reduced by executing at least one of the following methods: throttling a processor, powering down a disk drive, slowing memory access, or powering down auxiliary blades.

8. An apparatus, comprising:
a power supply having an input and an output wherein the input is coupled to a power distribution system;
a device coupled to the output of the power supply wherein the power supply supplies power to the device;
an energy storage device coupled to the output of the power supply and to the device;
wherein the power supply supplying power to both the device and the energy storage device when the power drawn by the device is not above a power capping limit;
wherein power to the device is supplied from both the power supply and the energy storage device when the power drawn by the device is above the power capping limit;
a power manager, the power manager reducing the load drawn by the device when at least one of the following conditions occur:
the power draw from fee energy storage device is above a first power draw threshold amount;
the total energy drawn from the energy storage device exceeds an energy threshold amount;
the power draw by the load exceeds a second power draw threshold;
the energy remaining in the energy storage device tails below a energy level threshold.

9. The apparatus of claim 8, wherein the power distribution system is an external AC power distribution system.

10. The apparatus of claim 8, wherein the device is comprised of at least one of the following devices: a computer system 1005 a rack 102, a processor blade 104, a controller 110, a bus 116, an I/O board 120, and an auxiliary blade 118.

11. The apparatus of claim 8, wherein the power drawn by the load is reduced by executing at least one of the following methods: throttling a processor, powering down a disk drive, slowing memory access, or powering down auxiliary blades.
